(19) United States
(12) Patent Application Publication
(10) Pub. No.: US 2010/0004042 A1
(43) Pub. Date: Jan. 7, 2010

(54) Blackjack game with side bet

(76) Inventors: Mark L. Yoseloff, Henderson, NV (US); Roger M. Snow, Las Vegas, NV (US); James P. Jackson, Henderson, NV (US)

Correspondence Address: Mark A> Litman and Associates, P.A.;York Business Center, 3209 w. 76th Street, Suite 205, Edina, MN, 55435, US

(21) Appl. No.: 12/217,144

(22) Filed: Jul. 1, 2008

(51) Int. Cl. A63F 13/00; A63F 1/00

(52) U.S. Cl. 463/12; 273/292; 463/25

(57) ABSTRACT

A method of playing a wagering game is disclosed. The game is a blackjack variant played by making two wagers and playing against a dealer hand. Each player makes two initial wagers. The dealer deals three cards to the player, and the player arranges the cards into a first two-card hand and a second one-card hand. The first wager is placed at risk with the first two-card hand and the second wager is placed at risk with the second one-card hand. The dealer also receives an initial two-card hand. The dealer deals the player one additional card to complete the second hand, and then the two-card hands are played out using traditional blackjack rules. The house takes a commission on the first and second wagers. An optional three-card poker side bet is provided in one embodiment.

### FIELD OF THE INVENTION

The present invention relates to card games, particularly to blackjack card games and its variants and more particularly to underlying Blackjack card games and variants with side bets on events that substantially do not influence the underlying strategies in the play of the underlying Blackjack game.

### BACKGROUND OF THE ART

Card games have always been popular as wagering games. The history of card games reaches back into biblical times. One of the most popular card games, especially for gambling or gaming uses is the card game known as Blackjack (or “21”) wherein a blackjack player plays against a dealer and the object is to beat the dealer's hand by reaching a total point value closest to 21, without exceeding a point count of twenty-one and/or by having the dealer's point count exceed twenty-one. The player may exercise strategies including adjusting his point count either by maintaining his original cards and card count (e.g., referred to as “standing,” not drawing a card that might cause the Blackjack player to ‘bust’, that is go over 21) and hope that the dealer will bust or by accepting additional cards (referred to as ‘hitting’ or ‘taking a hit’), attempting to receive a cumulative point card total higher (not exceeding a total point count of 21) than the total point count that the Dealer will ultimately attain. If both the Blackjack player and the dealer each achieve a point count total that does not exceed 21, then the highest total (as between individual players and the dealer) wins the bet. Blackjack is relatively simple to understand and is usually a faster and easier card game to play than, for example, the game of Poker. Blackjack, which can be played with the dealer and only one Blackjack player, tends to be more popular than the conventional game of Poker which needs to be played with several players because each of the Poker players are competing against each other for one pot whereas each Blackjack player can win against the one dealer. Even with variants of poker being played in casinos (e.g., Let It Ride® poker, Three Card Poker®, Crazy 4 Poker®, Caribbean Stud® poker, etc.), Blackjack remains the most popular card game in casinos, with many more tables usually dedicated to blackjack than to all other card games combined.

Blackjack must include a dealer (in mechanical, electromechanical, electronic or video versions of the game where a virtual dealer's hand is provided) and there must be at least one Blackjack player. One or more Blackjack players playing against the Dealer are, in effect, individually competing to try to either obtain a better total card point count than the point count of the dealer, without exceeding a total point count in the player's hand of 21 (for the total number of multiple playing cards that they the dealer is dealt). The player may stand after receiving a minimum of 2 cards and hope that the Dealer will bust. There are many variants on strategies that are used in the play of cards that are dependent upon a consideration of the player's cards in comparison with the dealer's cards. There are preferred and optimal strategies that may be used, with some strategies possibly influenced by card counting by the player.

For example, Blackjack players playing optional strategy, and seeing a dealer's exposed card as a 2, 3, 4, 5 or 6, will themselves elect to take no hits when the player's point count is 12, 13, 14, 15 or 16 in the hopes that the dealer's hitting (which is required when the dealer's point count is 16 or less) will result in a bust. The objective of the player is that with the exposed card being generally incapable of having a starting point count where the dealer may stand (the exception being a disclosed card of a 6 and a hole card of an ace), the dealer will take hits to a point total that exceeds 21 and therefore break (or “bust”), allowing the player to win the hand. The player will win the bet if the dealer has to hit (the Dealer is required to draw if their point total is 16 or less) and the Dealer busts (goes over 21).

Blackjack players also have the option of splitting any pairs (i.e., a pair of cards of identical point count value, such as two face cards, a 10 and a face card, a pair of 10s, a pair of 9s, a pair of 3's, etc.). Blackjack players have several other play options such as to double down (double their bet and receive only one more card), double their bet when they split a pair of cards, and can receive a 1.5 times their bet return if they receive an Ace and a 10 or picture card for their other card. A Blackjack player receiving a card score of more than 21 points has a bust hand and automatically loses to the dealer. If the dealer accumulates cards with a point count in excess of 21, the dealer busts, and every player remaining in the game (those players who have not busted themselves) wins the hand. The dealer, after receiving the first 2 cards begins drawing one or more cards (if the first 2 cards are 16 or less), but only after each of the Blackjack players at the dealer's table have played their hands to completion. Therefore, the house or casino has the advantage because the Blackjack player or players must play and complete their hand first or before the dealer plays or completes his hand. The Blackjack players at the table individually play against the dealer. The dealer must receive a minimum of 2 cards and attain a point count of at least 17 before the dealer may stop taking cards. Each of the Blackjack players individually playing against the dealer (who is a representative of the house or casino) has the option of standing after the receipt of their 2 initial cards. This means that the player will have the option of not receiving any other cards or to draw one or more other cards from the dealer and to continue drawing cards until the player is either satisfied with their card count score and stops drawing cards (stands) or the player has busted (gone over the 21 point total). As is known in the Blackjack card game, picture cards (Jacks, Queens and Kings) each have a point card value of 10 points while Aces have a point card value of either 1 point or 11 points. The other cards namely 2s, 3s, 4s, 5s, 6s, 7s, 8s, 9s and 10s have a point card value equivalent to their face card value (i.e., respectively 2, 3, 4, 5, 6, 7, 8, 9, and 10). In most gaming or casino establishments, dealers have to draw when they receive a point card value of 16 or less and, in some Casinos or gaming establishments, when they receive a point card value of 17 or less where the 17 point card value is based upon using an Ace as an 11 point card value with one or more other cards (this is known as a soft 17).

While Blackjack or 21 is a relatively fast-playing card game, it is always desirable to offer the players opportunities for variations in the game to maintain their long-term interest. Other betting options are desirable for the Blackjack player other than just varying the size of their wagers. Thus a Blackjack game is needed which would permit the Blackjack player to have a chance to win a large payout (as a regular option or an option after losing a number of conventional bets to the dealer) without the risk of losing a large bet that was the only previous option to try to promptly recoup a series of lost bets to the Dealer.

Attempts have been made to vary the game of Blackjack to a relatively minor degree wherein a Blackjack player could have more than one betting option other than the Blackjack player's bet to receive a higher card total not more than the maximum of 21 than the Dealer or to hope that the Dealer busts. However, these other attempts have not been successful because they do not provide a multitude of very exciting betting options combined with a large jackpot type of payout.

U.S. Pat. No. 5,454,570 to Karal discloses a Blackjack card game method therein a Blackjack player has extended wagering opportunities after the Blackjack player's hand has reached a desired card count value. Specifically, the Blackjack player can bet on whether the Dealer will achieve a card count that would be higher (but not greater than 21) than the Blackjack player's hand. This supplemental bet or wager by the Blackjack player is prior to the Dealer revealing the Dealer's face down card. Predetermined odds on the different possible Dealer hand combinations are paid to the Blackjack player in response to the selection of the point card value of the Dealer's hand. Also, the Blackjack player can wager on the point card value of the Dealer's only face down card. Furthermore, the Blackjack player can bet on the point card value of the third Dealer card, etc. The odds presented in this U.S. patent range from 10 to 1 (on an Ace being the Dealer down card or the next card to be drawn by the Dealer). Picture cards including 10's have 2 to 1 betting odds.

U.S. Pat. No. 5,275,416 (Schorr et al.) discloses a Blackjack card game method wherein a Blackjack player can bet on the Dealer's hand, the Blackjack player's hand or for a tie in the point count between the Dealer and the Blackjack player. The bet for the tie pays 9 to 1, the bet for the Blackjack player's hand pays even money (1 for 1), and the bet on the Dealer's hand pays 5 for 6 (five chips can be won on a 6 chip bet).

U.S. Pat. Nos. 5,154,429 and 5,257,789 (LeVasseur) disclose games in which a player plays the same hand against two or more successively dealt dealer's hands. To begin the game each player makes one or more antes to be eligible to participate against each of the dealer's hands. Each player and the dealer are dealt two cards with at least one of the dealer's cards turned face-up. Each player and the dealer then takes hits or stands according to the conventional manner of play of Twenty-One. The dealer's first hand is compared to the player's single hand. Winning player's wagers are paid and losing player's wages are collected, but only relative to the player's first ante. The dealer discards his first hand except for his face-up card, and then using the face-up card the dealer deals himself a “second” hand according to the conventional manner of play of Twenty-One. The dealer's second hand is compared to each of the player's same hand that the players played against the dealer's first hand. Again, winning player's wagers are paid and losing player's wagers are collected, but only relative to the player's second ante.

U.S. Pat. No. 7,036,821 (Hall) describes a card game in which each player places an initial bet on each of two or more hands to be played in accordance with rules of Blackjack, and also provides a further optional bet. A dealer then deals, from a set of cards, two or more hands of two cards to each player and a single hand of two cards to the dealer. The optional bet is then settled on a basis of all of the cards dealt to each player matching a specified hand, with the optional bet being paid out on a basis of a payout table. Each player then has an option to switch cards between the two or more hands. The two or more hands dealt to each player are then played out in a conventional Blackjack manner in order to settle the initial bets placed on each of the hands.

U.S. Pat. No. 6,863,274 (Webb) describes a variation in the game of blackjack in which players may make side bet wagers against a paytable on a three-card poker hand based on the combination of the player's first two cards and the dealer's up-card.

U.S. Pat. Nos. 5,322,295 and 5,636,842 (Cabot) describes cards games in which a dealer and at least one player wherein a winning hand will require a predetermined minimum number of cards. A deck of playing cards is provided comprising a plurality of cards wherein all cards have values which are greater than zero. A player makes at least one wager. A dealer provides the player with a plurality of cards for each wager made by the player. The dealer is initially provided with cards in a number greater than the minimum number required to form a winning hand and wherein each card in the dealer's hand and the player's hand(s) are counted in determining whether a player has achieved a winning hand. The dealer discards a number of cards equal to the number of cards received by said dealer which exceeded the minimum number required to form a hand.

Alternative game play for blackjack to attract new players and add new revenues is still desired.

### SUMMARY OF THE INVENTION

A wagering game has at least one player compete against a dealer in a game using blackjack rules in some wagering events. The at least one player places at least two wagers at risk. An optional side bet on a 2-card or 3-card poker hand may be made. The at least one player receives exactly three playing cards. The player arranges the exactly three cards into two initial blackjack hands of a first two-card hand and a second one-card hand. A first part of the at least two wagers is placed at risk with the first two-card hand and a second part of the at least two part wager is placed at risk with the second one-card hand. A dealer's initial two-card hand is provided. The dealer deals one additional card to complete the second blackjack hand. at least two wagers are resolved according to blackjack rules.

### BRIEF DESCRIPTION OF THE FIGURES

FIG. 1 shows a format for a game table layout enabling play of a game according to the present technology.

### DETAILED DESCRIPTION OF THE INVENTION

A wagering game has at least one player compete against a dealer in a game using blackjack rules in some wagering events. The at least one player places at least two wagers at risk. An optional side bet on a 2-card or 3-card poker hand may also be made. The at least one player receives exactly three playing cards. The player arranges the exactly three cards into two initial blackjack hands of a first two-card hand and a second one-card hand. Preferably, no restrictions are made on how to set the hands. In other embodiments, players are not permitted to combine aces into one hand, or to break up a Blackjack for example. A first of the at least two wagers is placed at risk with the first two-card hand and a second of the at least two wagers is placed at risk with the second one-card hand. A dealer's initial two-card hand is provided. The dealer provides a second card to the player to complete the second initial blackjack hand. The dealer completes the dealer's initial two-card hand; and the at least two hands are played and are resolved according to blackjack rules.

The at least two wagers may be required to be equal in value or to be fixed multiples of each other (e.g., the first bet equals 1× and the second bet is 1×, or 2× or 3×). Where the two bets are unequal, rules may be applied to the game to assure that placement of the wagers is controlled by rules. For example, it could be a rule that a larger wager cannot be placed on a hand that results in a blackjack, or on a hand that results in an initial count of 19 or 20. In these instances, the player might be required to switch wagers after the player sets his two hands. It might also be a rule that no double downs are allowed on a hand on which the larger wager is placed. Other rules require the larger wager to be placed on the one card hand. The side bet wager may have a value independent of the value of each of the two wagers, such as if the individual parts of the at least two wagers are 1×, the side bet wager against a paytable may be 1× up to the table limit, at the discretion of the player.

The side bet wager is easily and preferably resolved before the at least one player completes either of the two initial blackjack hands. The dealer hand is preferably dealt in a continuing sequence of cards being delivered along with the exactly three playing cards of the at least one player. This is typical of card distribution in blackjack games, although some clear variations may be needed, as described below.

Ordinarily in blackjack, cards are dealt one at a time to each position in a clockwise manner. This is easily done because each position receives the same number of initial cards (two cards). In the present game, however, the dealer's position and each player's position do not receive the same number of cards. Therefore, some variation is possible and tolerable in the dealing order. Cards may be dealt in continually distributed batches, such as three-cards to each player and two cards to the dealer, before resolution of the three-card poker side bet. That resolution may even be done before delivery of the two-card hand to the dealer. Cards may be dealt one-at-a-time (preferably clockwise to maintain the greatest consistency with blackjack formats), so that each player and the dealer receive two cards, and then individual third cards are then dealt to each player, without the dealer receiving the third card. An alternative method would be to deliver two cards in batches to each player and the dealer, and then provide third cards to each player, or to each player, one-at-a-time, allowing the individual players to resolve the 3-card side bet and then resolve each blackjack round before the next player receives the third card. These variations all fall within the generic description for play of the game. In another embodiment, each player and the dealer receive three cards, and the dealer turns one of his or her down cards.

The resolution of the at least two wagers may be limited to pay 1:1 odds on a blackjack for the at least one player as the probability of obtaining a blackjack has been significantly increased by being provided with three cards and then being allowed to select any two of the three cards to form a blackjack.

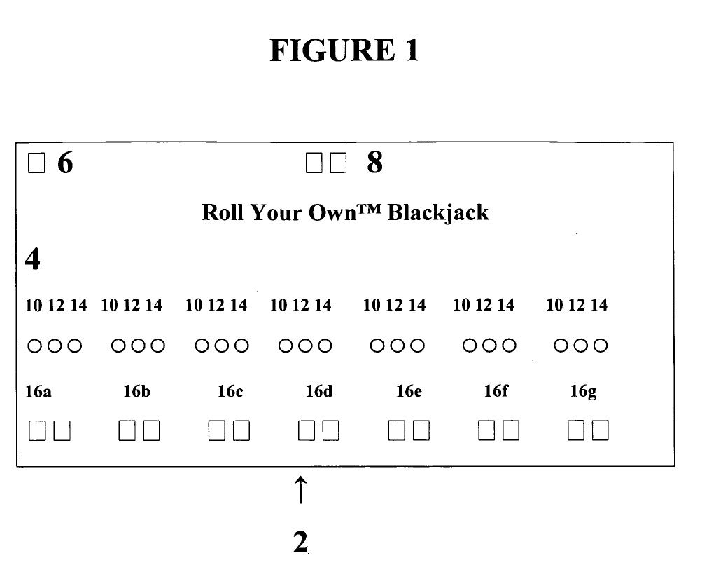

An example of a table layout 2 is shown in FIG. 1. The layout 2 shows a table surface 4 shuffler or dealer's card delivery tray 6 and dealer's hand position 8. Three separate betting positions 10, 12 and 14 are shown at each player's position, along with two separate hand location positions 16a-16f at each player's position.

In one embodiment, the player has the option to wager on the occurrence of the players initial three cards having a pre-determined poker ranking with corresponding payout odds. This optional wager may be placed in wagering position 14 shown in FIG. 1. The paytable on a poker rank has awards and may be, for example, comprised within ranges in the following table:

TABLE I

| | |
|---|---|
| Mini Royal (same-suited A-K-Q): | 50-150:1 |
| Straight Flush: | 20-50:1 |
| Three of a Kind: | 15-40:1 |
| Straight: | 3-6:1 and |
| Flush: | 2-4:1. |

The paytable may also include an award for a pair.

The side bet may be resolved prior to or after resolution of the underlying blackjack games. One preferred mode of the game requires resolution of the side bet after the player hands are set and the 4^{th} initial card is dealt. In other embodiments, the side bet is resolved after the blackjack hands are resolved.

In the game of the present technology, which may be referred to as Roll-Your-Own Blackjack™ game, players may be required to pay a commission (to the house) for example between 1-30%, preferably between 5-25% and most preferably about 20% up front that is collected regardless of game outcome on the at least two wagers, but not necessarily on the side bet wager. The commission may be collected as soon as wagers are placed or may be paid as a separate payment to the house when the initial wagers are made. For example, if each of the at least two wagers is $5.00 ($10.00 total), the player would provide a $2.00 (20%) separate contribution to the house. The house may also collect the contribution only on winning hands in a manner similar to fees in Pai Gow poker. The amount of the commission may vary depending on casino design, paytables and effects of other rules. For example, if hands may not be allowed to be arranged as blackjacks, except where the three-card initial deal to a player is two 10-count cards and an ace, a lower commission could be allowed than if blackjacks were allowed to be formed. Commissions may, for example, range from 1% to 30%, or may be a fixed amount paid on each hand independent of the amount of the actual wager. This might cause casinos to narrow allowed betting ranges, but at the same time charging a fixed fee would stimulate higher wagers within the allowed range to minimize the effect of the commission.

In another embodiment, instead of paying a commission, the player is required to make a three card poker wager equal to at least one of the player's Blackjack wagers. The hit frequency on this bet is about 10% with an approximate 32% house advantage. The pay table is preferably as follows:

Paytable II

Mini Royal: 100:1

Straight Flush: 40:1

Three of a Kind: 30:1

Straight: 5:1

Flush: 3:1

(Pairs may or may not be paid 1:1)

The technology of the present invention may be played as a real casino table card game with physical playing cards, live dealer and chips. The technology may also be played as a completely electronic game on a single video gaming platform (similar to commercially available video poker or video blackjack formats, with the game controller and processor content enabling play according to the rules described herein) or on a multi-player all electronic gaming platform as disclosed in U.S. Publication No. 2005/0164759 A1, assigned to Shuffle Master, Inc. Alternatively a blended physical and electronic gaming system may be used. In these systems various formats may be provided. Either physical cards (with a live dealer) and electronic only wagering are used, or physical cards with electronic card displays and electronic wagering may be used, or systems using physical chips and virtual cards (with a live dealer) and other combinations of physical elements of a standard live casino table wagering game and electronic support may be used.

Such electronic systems would have at least a monitor for view by players, either as a single monitor or individual monitors at each player position. A game controller would effect execution of the rules of the game, and possibly handle all accounting information, or the accounting functions could be separately supported on a table processor or a central processor. Playing cards in a physical game may be manually shuffled or a single deck or multi-deck playing card shuffler may be used. All Electronic multiplayer systems such as those described in U.S. Publication Nos. 2004/0224777 and 2005/0164762 may be used, and these applications and all other documents referenced herein are incorporated by reference.

Alternative formats for play could be performed on internet connections, internal casino network or inter-casino network, hand-held gaming devices, and hand held wireless communication devices that operate in a slave-master or thin-client relationship with a processor operating the game. Games may be played using actual wagers or may us non-monetary credit wagering for practice play or pure entertainment purposes. The games may be played as a communal game, with all players wagering on a single common event (as described in U.S. patent applications Ser. No. 11/595,738, filed Nov. 20, 2006 and U.S. Ser. No. 10/660,963 filed Sep. 12, 2003, each of which is incorporated herein by reference).

### Example I

The following example is illustrative of a mode of play of a game within the scope of the disclosed technology. Only three players and a live dealer are shown to simplify the explanation.

Each of the three players places a two-part wager of $20 in two equal $10 segments. In this version, the casino takes a 5% commission on each initial wager, so each player gives $2 to the dealer who removes the commission from play. Player 1 places a $10 side bet wager and player 3 makes a $25 side bet wager.

The dealer deals the playing cards and the final resulting initial cards are shown on the table, with only a dealer up-card displayed:

| | | | | |
|---|---|---|---|---|
| (BETS) | 10/10/5 | 10/10/0 | 10/10/25 | |
| | Player 1 | Player 2 | Player 3 | Dealer |
| | 3♡, 7♡, 8♡ | J♦, 9 [symbol] , 3 [symbol] | K♦, 6 [symbol] , 5♡ | 8 ♦ |
| WAGERS: | 10/10/5 | 10/10/0 | 10/10/25 | |

Player 1 wins 3:1 or 15 for being dealt a flush (TABLE II applies) on the side bet. Players then set their two hands as follows

| Player 1 | Player 2 | Player 3 | Dealer |
|---|---|---|---|
| 3♡, 8♡ and 7♡ | J♦, 9 [symbol] and 3 [symbol] | K♦ and 6 [symbol] 5♡ | 8 ♦ |

The players hit each hand to conclusion following standard blackjack rules and the final results of the play end up as hands having counts of:

| Player 1 | Player 2 | Player 3 | Dealer |
|---|---|---|---|
| 18 and Bust | 19 and 18 | 17 and 20 | 18 |

Player 1 ties (pushes) on his first hand and busts on his second hand. Player 2 wins his first hand and ties his second hand (pushes). Player 3 loses his first hand and wins his second hand.

### Example II

Each of the three players places a two-part wager of $20 in two $10 segments. In this version, the casino takes no commission on each initial wager. Player 2 places a $10 side bet wager and player 3 makes a $15 side bet wager.

The dealer deals the playing cards and the final resulting initial cards are shown on the table, with only a dealer up-card displayed:

| | Player 1 | Player 2 | Player 3 | Dealer |
|---|---|---|---|---|
| | 10 [symbol] , 7♡, 8♦ | J♦, 9 [symbol] , 10 [symbol] | K♦, K [symbol] , 5♡ | 8 ♦ |
| WAGERS | 10/10/0 | 10/10/10 | 10/10/15 | |

Player 2 has a straight that according to TABLE II wins 5:1 ($50.00) on a straight (9-10-J) on the side bet. Player 3 would win $15 on the side bet only if the existing pay table shows 1:1 for a Pair. Players then rearrange their hands as follows

| Player 1 | Player 2 | Player 3 | Dealer |
|---|---|---|---|
| 10 [symbol] 8♦ and 7♡ | J♦, 10 [symbol] and 9 [symbol] | K♦ K [symbol] and 5♡ | 8 ♦ |

The players hit each hand to conclusion and the final results of the play end up as hands having counts of:

| Player 1 | Player 2 | Player 3 | Dealer |
|---|---|---|---|
| 18 and Bust | 20 and 18 | 17 and 20 | 19 |

Player 1 loses both wagers. Player 2 wins the first wager and loses the second. Player 3 wins the second one wager and loses first.

Although specific examples and numbers have been provided herein, the disclosure is intended to be generic and encompass alternatives and equivalents and the claims are to be interpreted in that light.

What is claimed:

1. A method of playing a wagering game of at least one player against a dealer comprising:
the at least one player placing at least two wagers at risk:
the at least one player receiving exactly three playing cards:
the player arranging the cards into a first initial two-card blackjack hand and a second one-card blackjack hand;
a first part of the at least two wagers is placed at risk with the first two-card hand and a second part of the at least two part wager is placed at risk with the second one-card hand;
a dealer's initial two-card hand is provided;
the dealer dealing each player one additional card to each player completes the second initial blackjack hand; and
resolving the at least two wagers according to blackjack rules.

2. The method of claim 1 wherein the at least one player makes a side bet wager against a paytable on a poker rank for the exactly three playing cards.

3. The method of claim 1 wherein the at least two wagers are required to be equal in value.

4. The method of claim 3 wherein the at least one player makes a side bet wager against a paytable on a poker rank for the exactly three playing cards.

5. The method of claim 4 wherein the side bet wager has a value independent of the value of each of the two wagers.

6. The method of claim 2 wherein the side bet wager is resolved before the at least one player completes either of the two initial blackjack hands.

7. The method of claim 1 wherein the dealer hand is dealt in a continuing sequence of cards being delivered along with the exactly three playing cards of the at least one player.

8. The method of claim 1 wherein resolving the at least two wagers pays 1:1 odds on a blackjack for the at least one player.

9. The method of claim 2 wherein resolving the at least two wagers pays 1:1 odds on a blackjack for the at least one player.

10. The method of claim 2 wherein the paytable on a poker rank has awards comprised within ranges in the following table:
Mini Royal: 50-150:1
Straight Flush: 20-50:1
Three of a Kind: 15-40:1
Straight: 3-6:1 and
Flush: 2-4:1.

11. The method of claim 10 wherein the paytable also includes an award for a pair.

12. The method of claim 1 wherein a casino takes a commission on the at least two wagers.

13. The method of claim 2 wherein the side bet wager is mandatory.

14. The method of claim 1 wherein a casino takes no direct commission on any wagers.

15. The method of claim 1 wherein the cards are physical cards and all wagering is performed electronically.

16. The method of claim 1 wherein data representing card values in hands are provided to a game controller and all wager resolutions and accounting is performed electronically.

17. An apparatus comprising at least one video display screen to be viewed by a player, a game controller enabling play of a wagering game according to the method of claim 1, and a processor that enables accounting functions on wagers made, winnings and losses.

18. The apparatus of claim 17 wherein the game controller and the processor are a single processor.

19. The method of claim 1 wherein a house commission between 1% and 30% is paid on each at least two wagers.

20. The method of claim 1 wherein the games rules restrict the manner in which the player arranges his cards to prevent splitting of an Ace and 10 card combinations and requires splitting of pairs of Aces.
